(19) United States
(12) Patent Application Publication
(10) Pub. No.: US 2012/0213883 A1
(43) Pub. Date: Aug. 23, 2012

(54) INJECTION MOLD

(75) Inventors: XIAN-YUN WANG, Dong-Guan (CN); XIAO-PING WU, Dong-Guan (CN); KUN-HSUEH CHIANG, New Taipei City (TW)

(73) Assignee: Cheng Uei Precision Industry Co., Ltd., New Taipei City (TW)

(21) Appl. No.: 13/033,580

(22) Filed: Feb. 23, 2011

(51) Int. Cl. B29C 45/40

(52) U.S. Cl. 425/556

(57) ABSTRACT

An injection mold is adapted for ejecting out an insert-molding product and an injecting waste material connected with the insert-molding product one after another in turn. The injecting mold includes a fixed mold and a movable mold movably engaged with the fixed mold to define a chamber for molding the insert-molding product and a sprue channel for molding the injecting waste material therebetween. In the process of ejecting the insert-molding product and the injecting waste material out of the injection mold, The injection mold has at least one product ejector pin used to make the insert-molding product separated from the injecting waste material and then eject the insert-molding product out of the injection mold firstly, and at least one delay ejector pin used to eject the injecting waste material out of the injection mold after the insert-molding product are ejected out of the injection mold.

### BACKGROUND OF THE INVENTION

1. Field of the Invention

The present invention relates to an injection mold, and particularly to an injection mold adapted for ejecting out an insert-molding product and an injecting waste material connected with the insert-molding product one after another in turn.

2. The Related Art

A conventional injection mold includes a fixed mold and a movable mold engaged with the fixed mold. A chamber and a sprue channel communicating with the chamber are formed between the movable mold and the fixed mold for respectively molding an insert-molding product and an injecting waste material connected with the insert-molding product. A plurality of the ejector pins is fixed on the movable mold for ejecting the insert-molding product and the injecting waste material out of the injection mold at the same time.

However, the insert-molding product and the injecting waste material are still connected with each other after being ejected out of the injection mold by the ejector pins. In order to obtain the insert-molding product, the injecting waste material must be removed from the insert-molding product by worker. So it is necessary to provide an injection mold which is capable of automatically removing the injecting waste material from the insert-molding product.

### SUMMARY OF THE INVENTION

Accordingly, an object of the present invention is to provide an injection mold. The injection mold is adapted for ejecting out an insert-molding product and an injecting waste material connected with the insert-molding product one after another in turn. The injecting mold comprises a fixed mold and a movable mold movably engaged with the fixed mold to collectively define a chamber for molding the insert-molding product and a sprue channel for molding the injecting waste material therebetween, with the chamber communicating with the sprue channel. The movable mold has a fixing plate and a movable mold core apart mounted over the fixing plate, with a moving space being formed between the movable mold core and the fixing plate. An ejector retainer plate is movably accommodated in the moving space and defines at least one passing hole penetrating through a bottom face thereof. An ejector plate is fastened on the ejector retainer plate and cooperates with the ejector retainer plate to define a limiting space therebetween. The ejector plate defines at least one through hole penetrating through a top face thereof. The limiting space is connected with a top of the passing hole and a bottom of the through hole. At least one product ejector pin each has a lower end fixed in the ejector plate. An upper end of the product ejector pin movably passes through the movable mold core and further pushes the insert-molding product upward to make the insert-molding product separated from the injecting waste material and then ejected out of the injection mold when the ejector retainer plate moves upward. At least one delay ejector pin each has a stopping, with a thickness being smaller than the depth of the limiting space, capable of being movably accommodated in the limiting space. A portion of a top surface of the stopping protrudes upward to form an ejector rod movably passing through the ejector plate and the movable mold core. At least one propping mechanism is inserted in the passing hole and resists against the stopping and the fixing plate to make a free end of the ejector rod prop against a bottom side of the injecting waste material when the injection mold is at a mold-closing position. In the process of the insert-molding product being ejected out of the injection mold, the delay ejector pin keeps stationary with respect to the movable mold core and moves downward with respect to the ejector plate. After the insert-molding product is ejected out of the injection mold, a bottom surface of the stopping gets in touch with a bottom side of the limiting space, then the ejector retainer plate keeps moving upward to push the stopping upward and further drive the free end of the ejector rod to eject upward the injecting waste material out of the injection mold.

As described above, in the process of ejecting the insert-molding product and the injecting waste material out of the injection mold, the product ejector pin and the delay ejector pin can eject the insert-molding product and the injecting waste material connected with the insert-molding product out of the injection mold one after another in turn. So, the injection mold can satisfy the requirement of automatically removing the injecting waste material from the insert-molding product. Furthermore, the production efficiency of the insert-molding product can be effectively improved and the cost of human resource is further lowered.

### BRIEF DESCRIPTION OF THE DRAWINGS

The present invention will be apparent to those skilled in the art by reading the following description thereof, with reference to the attached drawings, in which:

FIG. 1 is a partially cross-sectional view illustrating an injection mold at a mold-closing position in accordance with an embodiment of the present invention;

FIG. 2 is a partially cross-sectional view illustrating a movable mold core of a movable mold engaged with a fixed mold of the injection mold, wherein the injection mold is at the mold-closing position;

FIG. 3 is a partially cross-sectional view illustrating the movable mold of the injection mold of FIG. 1 at a state of mold-opening;

FIG. 4 is a partially cross-sectional view illustrating the movable mold of the injection mold of FIG. 1 at another state of mold-opening;

FIG. 5 is a partially cross-sectional view illustrating a limiting space of the injection mold in accordance with a first embodiment of the present invention;

FIG. 6 is a partially cross-sectional view illustrating the limiting space of the injection mold in accordance with a second embodiment of the present invention; and

FIG. 7 is a partially cross-sectional view illustrating the limiting space of the injection mold in accordance with a third embodiment of the present invention.

### DETAILED DESCRIPTION OF THE EMBODIMENT

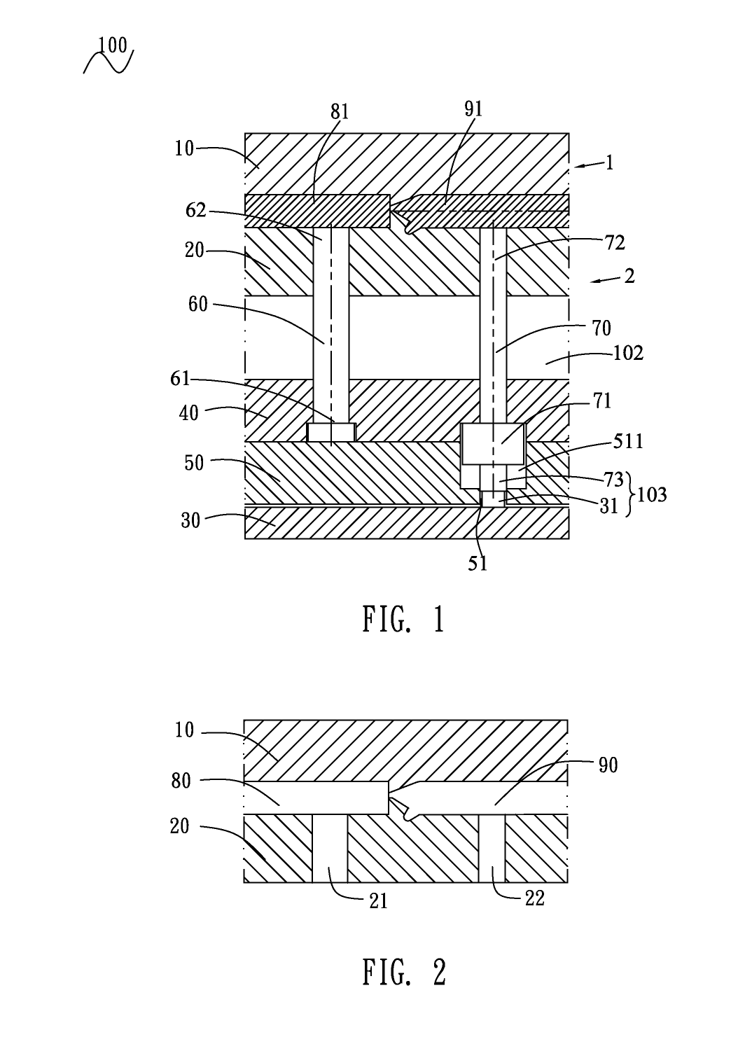

Referring to the drawings in greater detail, and first to FIGS. 1-2, the embodiment of the invention is embodied in an injection mold 100 adapted for ejecting an insert-molding product 81 and an injecting waste material 91 connected with the insert-molding product 81 out of the injection mold 100 one after another in turn. The injection mold 100 comprises a fixed mold 1 and a movable mold 2 movably engaged with the fixed mold 1 to collectively define a chamber 80 for molding the insert-molding product 81 and a sprue channel 90 for molding the injecting waste material 91 therebetween, with the chamber 80 communicating with the sprue channel 90.

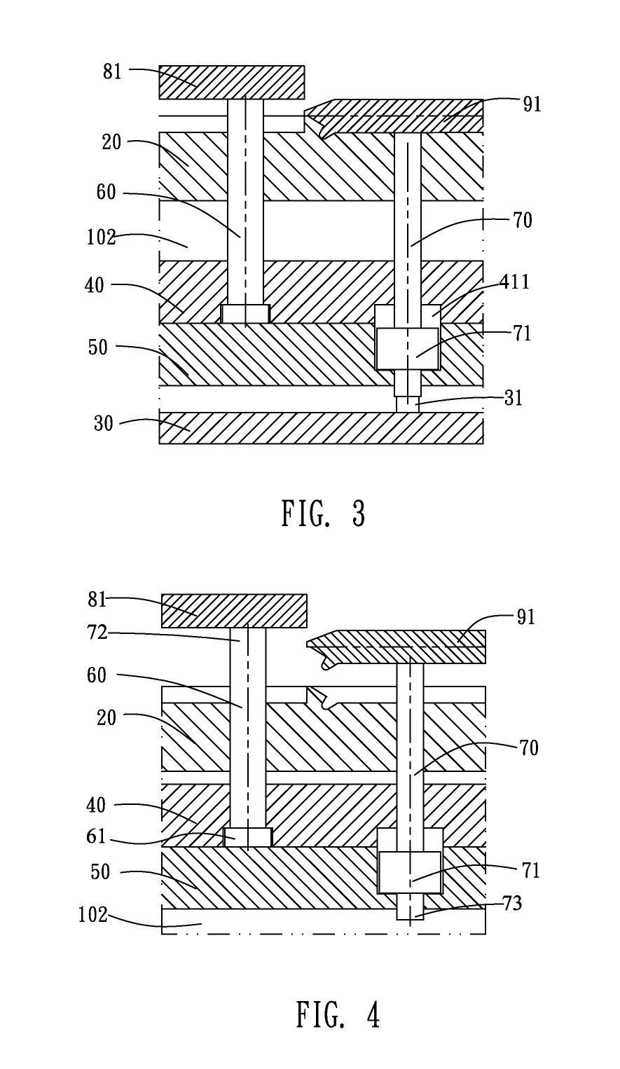

Refer to FIGS. 1-4. The movable mold 2 has a fixing plate 30 fixed to a molding apparatus (not shown). A movable mold core 20 is mounted over the fixing plate 30, with a moving space 102 being formed therebetween. A bottom surface of the movable mold core 20 defines at least one inserting hole 21 penetrating upward through the movable mold core 20 to connect with the chamber 80, and at least one penetrating hole 22 penetrating upward through the movable mold core 20 to connect with the sprue channel 90. An ejector retainer plate 50 is movably accommodated in the moving space 102 and capable of engaging with the fixing plate 30. The ejector retainer plate 50 defines at least one passing hole 51 penetrating through a bottom face thereof. An ejector plate 40 is fastened on the ejector retainer plate 50 and cooperates with the ejector retainer plate 50 to define a limiting space 101 therebetween, wherein a top of the passing hole 51 is connected with a bottom of the limiting space 101. The ejector plate 40 defines a through hole 41 penetrating through a top face thereof with a bottom thereof connected with a top of the limiting space 101. In this embodiment, the limiting space 101 has a greater diameter than that of the passing hole 51 and the through hole 41. At least one product ejector pin 60 each has a lower end 61 fixed in the ejector plate 40, and an upper end 62 movably passing through the inserting hole 21 of the movable mold core 20 and further capable of projecting into the chamber 80 to eject the insert-molding product 81 out of the injection mold 100 under the drive of the ejector retainer plate 50. At least one delay ejector pin 70 each has a cylinder-shaped stopping 71 of which the thickness is smaller than the depth of the limiting space 101 to make the stopping 71 movably accommodated in the limiting space 101. A substantial middle of a top surface of the stopping 71 protrudes upward to form a substantially pillar-shaped ejector rod 72. The ejector rod 72 is capable of movably passing through the through hole 41 of the ejector plate 40 and the penetrating hole 22 of the movable mold core 20 to make a free end thereof project into the sprue channel 90 and further eject the injecting waste material 91 out of the injection mold 100 under the drive of the ejector retainer plate 50. A propping mechanism 103 is movably inserted in the passing hole 51 and resists against the stopping 71 and the fixing plate 30 to make the free end of the ejector rod 72 abut against a bottom side of the injecting waste material 91 when the injection mold 100 is at a mold-closing position. In this embodiment, as shown in the FIG. 1 and FIG. 3, the propping mechanism 103 includes a resisting pillar 31 protruding upward from a top surface of the fixing plate 30 and a propping pillar 73 protruding downward from a substantial middle of a bottom surface of the stopping 71 of the delay ejector pin 70. The axes of the ejector rod 72 and the propping pillar 73 coincide with the one of the stopping 71 viewed from the cross-sectional view, and further coincide with the one of the resisting pillar 31. In other embodiments, the propping mechanism 103 may only be the resisting pillar 31 having a height thereof substantially equal to a distance from the bottom surface of the stopping 71 to the top surface of the fixing plate 30 when the injection mold 100 is at the mold-closing position. Or, the propping mechanism 103 may only be the propping pillar 73 having a height thereof substantially equal to the distance from the bottom surface of the stopping 71 to the top surface of the fixing plate 30 when the injection mold 100 is at the mold-closing position.

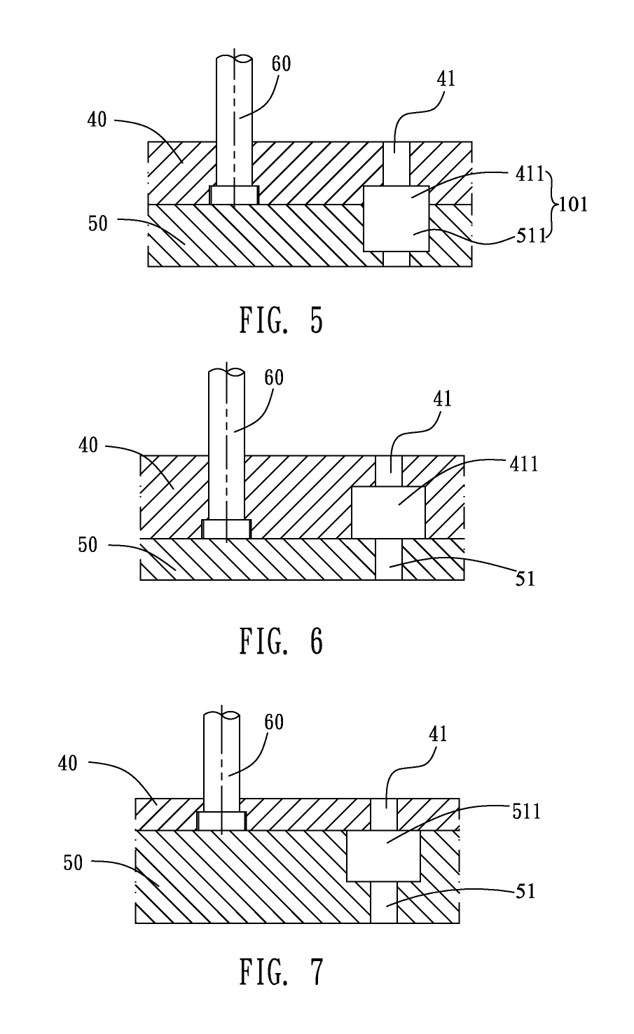

Refer to FIG. 1 and FIG. 5. In a first embodiment of the injection mold 100, the limiting space 101 is composed of an upper limiting groove 411 and a lower limiting groove 511 which have the same diameter. The upper limiting groove 411 is opened on the ejector plate 40 and penetrates through a bottom surface of the ejector plate 40, with a substantial middle of a top thereof being connected with the bottom of the through hole 41. The lower limiting groove 511 is opened on the ejector retainer plate 50 and penetrates through a top surface of the ejector retainer plate 50, with a substantial middle of a bottom thereof being connected with the top of the passing hole 51.

Refer to FIG. 6. In a second embodiment of the injection mold 100, the limiting space 101 only includes the upper limiting groove 411 capable of cooperating with the top surface of the ejector retainer plate 50 to define the said limiting space 101.

Refer to FIG. 7. In a third embodiment of the injection mold 100, the limiting space 101 only includes the lower limiting groove 511 capable of cooperating with the bottom surface of the ejector plate 40 to define the said limiting space 101.

Refer to FIG. 1. In the embodiment of the present invention, when the injection mold 100 is at the mold-closing position, the ejector retainer plate 50 abuts against the fixing plate 30. The resisting pillar 31 is received in the passing hole 51 and resists against a bottom end of the propping pillar 73 to make the top surface of the stopping 71 abut against a top side of the limiting space 101, with the upper end 62 of the product ejector pin 60 abutting against a bottom side of the insert-molding product 81 and the free end of the ejector rod 72 abutting against the bottom side of the injecting waste material 91.

Refer to FIG. 1 and FIGS. 3-4. In the process of ejecting the insert-molding product 81 and the injecting waste material 91 out of the injection mold 100, the fixed mold 1 firstly gradually detaches from the movable mold 2 to leave the insert-molding product 81 and the injecting waste material 91 on the movable mold 2. Then, in the moving space 102, the ejector plate 40 moves toward the movable mold core 20 under the drive of the ejector retainer plate 50. Because the lower end 61 of the product ejector pin 60 is fastened in the ejector plate 40, the movement of the ejector plate 40 and the ejector retainer plate 50 can drive the upper end 62 of the product ejector pin 60 to push upward the insert-molding product 81 so as to make the insert-molding product 81 separate from the injecting waste material 91 and further eject the insert-molding product 81 out of the injection mold 100 firstly. In the process of the insert-molding product 81 being ejected out of the injection mold 100, the delay ejector pin 70 keeps stationary with respect to the movable mold core 20 until the insert-molding product 81 is separated from the injecting waste material 91 to be ejected out of the injection mold 100 and the bottom surface of the stopping 71 gets in touch with a bottom side of the limiting space 101. At this time, the propping pillar 73 is inserted in the passing hole 51. As the ejector retainer plate 50 keeps moving toward the movable mold core 20, the ejector retainer plate 50 pushes the stopping 71 of the delay ejector pin 70 upward to drive the free end of the ejector rod 72 to eject upward the injecting waste material 91 out of the injection mold 100.

As described above, in the process of ejecting the insert-molding product 81 and the injecting waste material 91 out of the injection mold 100, the product ejector pin 60 and the delay ejector pin 70 can eject the insert-molding product 81 and the injecting waste material 91 connected with the insert-molding product 81 out of the injection mold 100 one after another in turn. So, the injection mold 100 can satisfy the requirement of automatically removing the injecting waste material 91 from the insert-molding product 81. Furthermore, the production efficiency of the insert-molding product 81 can be effectively improved and the cost of human resource is further lowered.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An injection mold adapted for ejecting out an insert-molding product and an injecting waste material connected with the insert-molding product one after another in turn, the injecting mold comprising a fixed mold and a movable mold movably engaged with the fixed mold to collectively define a chamber for molding the insert-molding product and a sprue channel for molding the injecting waste material therebetween, with the chamber communicating with the sprue channel, the movable mold having:
a fixing plate;
a movable mold core apart mounted over the fixing plate, with a moving space being formed between the movable mold core and the fixing plate;
an ejector retainer plate movably accommodated in the moving space and defining at least one passing hole penetrating through a bottom face thereof;
an ejector plate fastened on the ejector retainer plate and cooperating with the ejector retainer plate to define a limiting space therebetween, the ejector plate defining at least one through hole penetrating through a top face thereof, the limiting space being connected with a top of the passing hole and a bottom of the through hole;
at least one product ejector pin each having a lower end fixed in the ejector plate, an upper end of the product ejector pin movably passing through the movable mold core and further pushing the insert-molding product upward to make the insert-molding product separated from the injecting waste material and then ejected out of the injection mold when the ejector retainer plate moves upward;
at least one delay ejector pin each having a stopping, with a thickness being smaller than the depth of the limiting space, capable of being movably accommodated in the limiting space, a portion of a top surface of the stopping protruding upward to form an ejector rod movably passing through the ejector plate and the movable mold core; and
at least one propping mechanism inserted in the passing hole and resisting against the stopping and the fixing plate to make a free end of the ejector rod prop against a bottom side of the injecting waste material when the injection mold is at a mold-closing position;
wherein in the process of the insert-molding product being ejected out of the injection mold, the delay ejector pin keeps stationary with respect to the movable mold core and moves downward with respect to the ejector plate, after the insert-molding product is ejected out of the injection mold, a bottom surface of the stopping gets in touch with a bottom side of the limiting space, then the ejector retainer plate keeps moving upward to push the stopping upward and further drive the free end of the ejector rod to eject upward the injecting waste material out of the injection mold.

2. The injection mold as claimed in claim 1, wherein the limiting space includes an upper limiting groove opened on the ejector plate and penetrating through a bottom surface of the ejector plate, and a lower limiting groove opened on the ejector retainer plate and penetrating through a top surface of the ejector retainer plate, the upper limiting groove cooperates with the lower limiting groove to form the said limiting space.

3. The injection mold as claimed in claim 2, wherein the diameter of the lower limiting groove is substantially same as the one of the upper limiting groove.

4. The injection mold as claimed in claim 1, wherein the said limiting space is opened on the ejector retainer plate and penetrates through a top surface of the ejector retainer plate, the through hole of the ejector plate further penetrates through a bottom surface of the ejector plate to connect with the said limiting space.

5. The injection mold as claimed in claim 1, wherein the said limiting space is opened on the ejector plate and penetrates through a bottom surface of the ejector plate, the passing hole of the ejector retainer plate further penetrates through a top surface of the ejector retainer plate to connect with the said limiting space.

6. The injection mold as claimed in claim 1, wherein the propping mechanism includes a resisting pillar protruding upward from a top surface of the fixing plate, and a propping pillar protruding downward from a bottom surface of the stopping of the delay ejector pin and abutting against a top of the resisting pillar when the injection mold is at the mold-closing position.

7. The injection mold as claimed in claim 1, wherein the propping mechanism is a resisting pillar protruding upward from a top surface of the fixing plate for propping against a bottom surface of the stopping of the delay ejector pin to make the free end of the ejector rod prop against the bottom side of the injecting waste material when the injection mold is at the mold-closing position.

8. The injection mold as claimed in claim 1, wherein the propping mechanism is a propping pillar protruding downward from a bottom surface of the stopping of the delay ejector pin for resisting against a top surface of the fixing plate to make the free end of the ejector rod prop against the bottom side of the injecting waste material when the injection mold is at the mold-closing position.
